(19) United States
(12) Patent Application Publication
(10) Pub. No.: US 2006/0268720 A1
(43) Pub. Date: Nov. 30, 2006

(54) Method and apparatus for providing acknowledgement signaling in a multi-carrier communication system

(76) Inventors: Zhigang Rong, San Diego, CA (US); Lin Ma, San Diego, CA (US); Zhouyue Pi, San Diego, CA (US); Fei Frank Zhou, San Diego, CA (US)

Correspondence Address: DITTHAVONG & MORI, P.C., Suite A, 10507 Braddock Road, Fairfax, VA, 22032, US

(21) Appl. No.: 11/389,752

(22) Filed: Mar. 27, 2006

Related U.S. Application Data
(60) Provisional application No. 60/684,688, filed on May 26, 2005.

(51) Int. Cl. H04L 12/26

(52) U.S. Cl. 370/236; 370/335; 370/337

(57) ABSTRACT

An approach is provided for acknowledgement signaling in multi-carrier system. A plurality of acknowledgement signals are received corresponding to a plurality of transmission carriers. The transmission carriers are associated with a first direction of transmission. Some of the acknowledgement signals are allocated to a first transmitter branch, and remaining ones of the acknowledgement signals are allocated to a second transmitter branch. The plurality of acknowledgement signals are transmitted over a single transmission carrier associated with a second direction of transmission.

### RELATED APPLICATIONS

This application claims the benefit of the earlier filing date under 35 U.S.C. §119(e) of U.S. Provisional Application Ser. No. 60/684,688 filed May 26, 2005, entitled “Method and Apparatus for Providing Acknowledgement Signaling in a Multi-carrier Communication System,” the entirety of which is incorporated by reference.

### FIELD OF THE INVENTION

The invention relates to communications, and more particularly, to providing signaling in a multi-carrier system.

### BACKGROUND OF THE INVENTION

Radio communication systems, such as cellular systems (e.g., spread spectrum systems (such as Code Division Multiple Access (CDMA) networks), and Time Division Multiple Access (TDMA) networks), provide users with the convenience of mobility along with a rich set of services and features. This convenience has spawned significant adoption by an ever growing number of consumers as an accepted mode of communication for business and personal uses in terms of communicating voice and data (including textual and graphical information). As a result, cellular service providers are continually challenged to enhance their networks and services. The development of multi-carrier systems stem, in part, from the recognition that greater data rates are required to support sophisticated applications, and the general need for better system performance.

The use of Acknowledgements (ACKs) and/or Negative Acknowledgements (NACKs) are required to indicate whether data has been received successfully, or unsuccessfully. This mechanism is executed by a transmitter and a receiver to notify the transmitter whether the data has to be retransmitted. This mechanism can also support flow control of the data exchange between the transmitter and receiver, whereby the receiver conveys to the transmitter that the receiver is ready to receive more data. In a single carrier system, the ACK/NACK signaling can be implemented in a relatively straightforward manner. By contrast, in the multi-carrier system, the use of ACK/NACK signals for each carrier is inefficient, and undermines the purpose of utilizing multi-carriers in the first place—that goal of greater usable bandwidth and associated throughput. Furthermore, carrier reallocation can be fast and adaptive in multi-carrier systems, which makes ACK feedback very complicated. At the same, the back compatibility with conventional single carrier systems (e.g., 1×EV-DO) may not be preserved. Thus, it is recognized that there is a need for an approach to efficiently accommodate ACK/NACK signals in a multi-carrier system.

Therefore, there is a need for an approach to provide more efficient signaling in multi-carrier systems.

### SUMMARY OF THE INVENTION

These and other needs are addressed by the invention, in which an approach is presented for acknowledgement signaling in a multi-carrier system.

According to one aspect of an embodiment of the invention, a method comprises receiving a plurality of acknowledgement signals corresponding to a plurality of transmission carriers. The transmission carriers are associated with a first direction of transmission. The method also comprises allocating some of the acknowledgement signals to a first transmitter branch. The method also comprises allocating remaining ones of the acknowledgement signals to a second transmitter branch. The method further comprises transmitting the plurality of acknowledgement signals over a single transmission carrier associated with a second direction of transmission.

According to another aspect of an embodiment of the invention, an apparatus comprises circuitry configured to receive a plurality of acknowledgement signals corresponding to a plurality of transmission carriers. The transmission carriers are associated with a first direction of transmission. The circuitry is further configured to allocate some of the acknowledgement signals to a first transmitter branch and remaining ones of the acknowledgement signals to a second transmitter branch. The plurality of acknowledgement signals are transmitted over a single transmission carrier associated with a second direction of transmission.

According to another aspect of an embodiment of the invention, a method comprises transmitting a plurality of acknowledgement signals corresponding to a plurality of transmission carriers to a terminal. The transmission carriers are associated with a first direction of transmission, wherein some of the acknowledgement signals are allocated to a first transmitter branch of the terminal and remaining ones of the acknowledgement signals are allocated to a second transmitter branch of the terminal. The method also comprises receiving the plurality of acknowledgement signals over a single transmission carrier associated with a second direction of transmission.

According to yet another aspect of an embodiment of the invention, an apparatus comprises a first communication interface configured to transmit a plurality of acknowledgement signals corresponding to a plurality of transmission carriers to a terminal. The transmission carriers are associated with a first direction of transmission, wherein some of the acknowledgement signals are allocated to a first transmitter branch of the terminal and remaining ones of the acknowledgement signals are allocated to a second transmitter branch of the terminal. The apparatus also comprises receiving the plurality of acknowledgement signals over a single transmission carrier associated with a second direction of transmission.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a wireless system including an Access Network (AN) and an Access Terminal (AT) configured to support ACK/NACK signaling, in accordance with an embodiment of the invention;

FIG. 2 is a flowchart of a process for providing multiple acknowledgements in a single reverse link, in accordance with an embodiment of the invention;

FIG. 3 is a diagram of channel structure for providing TDM (Time Division Multiplexing)-ACKs utilizing both In-phase (I) and Quadrature (Q) branches, in accordance with an embodiment of the invention;

FIG. 4 is a diagram of channel structure of CDM (Code Division Multiplexing)-ACKs utilizing both I and Q branches, in accordance with an embodiment of the invention;

FIG. 5 is a diagram of channel structure of CDM (Code Division Multiplexing)-ACKs utilizing only the I branch;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF THE PREFERRED EMBODIMENT

An apparatus, method, and software for allocating acknowledgement (ACK/NACK) signals to both In-phase (I) and Quadrature (Q) branches of a transmitter are described. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the invention.

Although the invention is discussed with respect to a radio communication network (such as a cellular system), it is recognized by one of ordinary skill in the art that the invention has applicability to any type of communication systems, including wired systems.

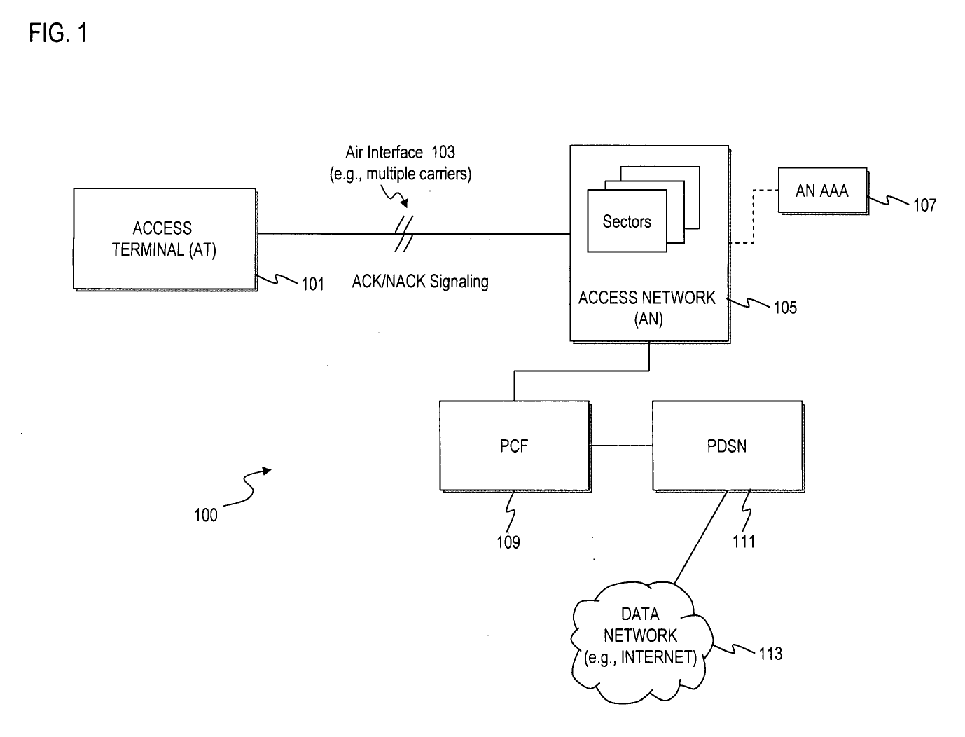

FIG. 1 is a diagram of the architecture of a wireless system including an Access Network (AN) and an Access Terminal (AT) configured to support ACK/NACK signaling, in accordance with an embodiment of the invention. By way of example, a radio network operates according to the Third Generation Partnership Project 2 (3GPP2) standard for supporting High Rate Packet Data (HRPD). The radio network 100 includes one or more access terminals (ATs) 101 of which one AT 101 is shown in communication with an access network (AN) 105 over an air interface 103. In cdma2000 systems, the AT is equivalent to a mobile station, and the access network is equivalent to a base station. The AT 101 is a device that provides data connectivity to a user. For example, the AT 101 can be connected to a computing system, such as a personal computer, a personal digital assistant, and etc. or a data service enabled cellular handset. The radio configuration encompasses two modes of operations: 1× and multi-carrier (i.e., n×). Multi-carrier systems employ multiple 1× carriers to increase the data rate to the AT 101 (or mobile station) over the forward link. Hence, unlike 1× technology, the multi-carrier system operates over multiple carriers. In other words, the AT 101 is able to access multiple carriers simultaneously.

The AN 105 is a network equipment that provides data connectivity between a packet switched data network, such as the global Internet 113 and the AT 101. The AN 105 communicates with a Packet Data Service Node (PDSN) 111 via a Packet Control Function (PCF) 109. Either the AN 105 or the PCF 109 provides a SC/MM (Session Control and Mobility Management) function, which among other functions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety. Also, a more detailed description of the HRPD is provided in TSG-C.S0024-IS-856, entitled “cdma2000 High Rate Packet Data Air Interface Specification,” which is incorporated herein by reference in its entirety.

In addition, the AN 105 communicates with an AN-AAA (Authentication, Authorization and Accounting entity) 107, which provides terminal authentication and authorization functions for the AN 105.

Both the cdma2000 1×EV-DV (Evolution—Data and Voice) and 1×EV-DO (Evolution—Data Optimized) air interface standards specify a packet data channel for use in transporting packets of data over the air interface on the forward link and the reverse link. A wireless communication system may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals.

In the multiple-access wireless communication system, communications between users are conducted through one or more AT(s) 101 and a user (access terminal) on one wireless station communicates to a second user on a second wireless station by conveying information signal on a reverse link to a base station. The AN 105 receives the information signal and conveys the information signal on a forward link to the AT station 101. The AN 105 then conveys the information signal on a forward link to the station 101. The forward link refers to transmissions from an AN 105 to a wireless station 101, and the reverse link refers to transmissions from the station 101 to the AN 105. The AN 105 receives the data from the first user on the wireless station on a reverse link, and routes the data through a public switched telephone network (PSTN) to the second user on a landline station. In many communication systems, e.g., IS-95, Wideband CDMA (WCDMA), and IS-2000, the forward link and the reverse link are allocated separate frequencies.

The invention, according to an exemplary embodiment, accommodates a multiple of carriers' ACK/NACK signals (e.g., up to 6) in a single reverse link carrier, thereby advantageously saving reverse link resources if more than two ACK/NACK signals are to be transmitted. Also, the system of FIG. 1 can distribute the power to I and Q branch more evenly (i.e., minimizing I-Q imbalance), resulting in enhanced performance of the AT. I-Q imbalance can increase the signal Peak-to-Average-Power Ratio (PAPR), and thus, complicate the AT power amplifier design.

In an 1×EV-DO system, the AT 101 transmits ACK/NACK signal on a Reverse Acknowledgement Channel (R-ACKCH) to the AN 105 to indicate if the reception of the forward link packets is successful or not. With multiple carriers used, for example, in a N×DO system, the AT 101 needs to feedback multiple ACK/NACK signals to indicate the success or failure of the packet reception on all the carriers.

A few approaches with respect to how the AT 101 reports ACK/NACK for the different carriers have been proposed. For example, one approach involves Time Division Multiplexing (TDM) of ACK/NACK from two carriers by reducing the ACK/NACK transmission duration of each single carrier by half (e.g., to ¼ slot). One drawback of this approach is that each reverse link carrier can only accommodate ACK/NACK signals of two forward link carriers. If more than two forward link carriers are used to transmit data to the AT 101, the number of reverse link carriers need to be increased accordingly, regardless of the traffic loading on the reverse link. This will result in a waste of the reverse link resource, and consequently a shorter battery life of the AT 101, for example.

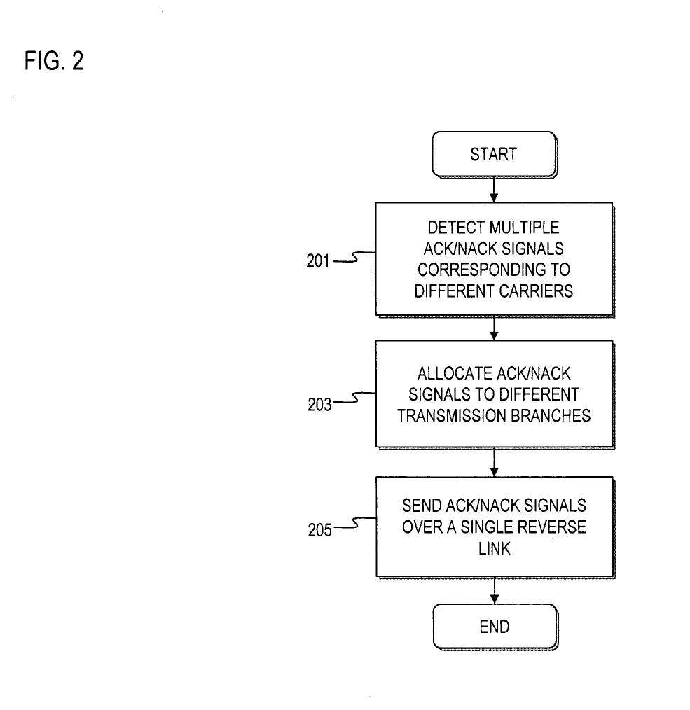

FIG. 2 is a flowchart of a process for providing multiple acknowledgements in a single reverse link, in accordance with an embodiment of the invention. In step 201, multiple ACK/NACK signals corresponding to multiple forward transmission carriers are detected and received. Next, these ACK/NACK signals are allocated to different transmission branches, per step 203. According to an exemplary embodiment, when multiple ACK/NACK signals are to be transmitted, instead of transmitting these signals on the same I-branch of the transmitter, the AT allocates the ACK/NACK signals to both I and Q branches of the transmitter. For example, if there are three forward carriers, f1, f2 and f3, the AT can allocate the ACK/NACK signals of f1 and f2 on the I-branch, and ACK/NACK signals of f3 on the Q-branch. Thereafter, the ACK/NACK signals are transmitted over a single reverse link, as in step 205.

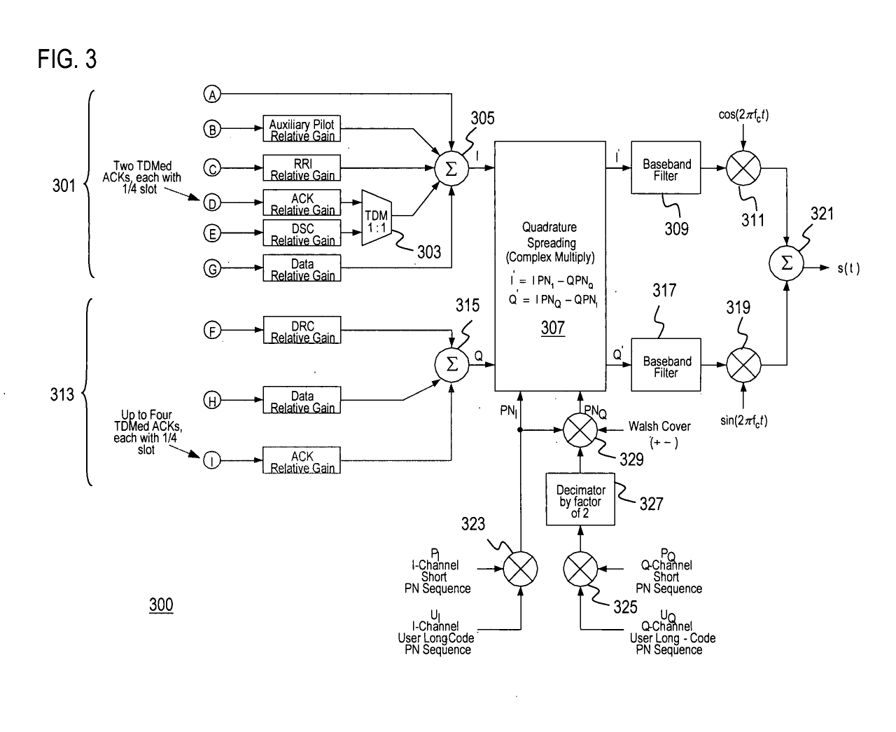

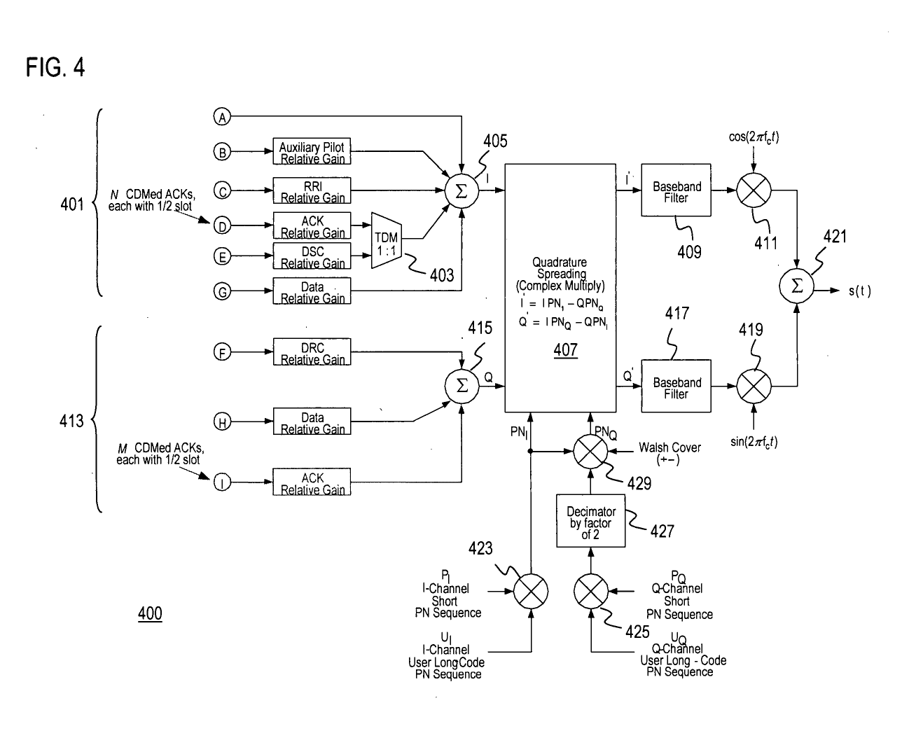

FIGS. 3 and 4, according to various embodiments of the invention, describe ACK/NACK signaling for TDM and CDM systems, respectively. With the TDM-ACK (shown in FIG. 3), where two ACK/NACK signals are multiplexed together (i.e., “TDMed”) on the reverse acknowledgement channel (R-ACKCH) using TDM, if more than two carriers on the forward link are to be supported by the AT 101, two of the ACK/NACK signals can be carried on the R-ACKCH on the I-branch, and the rest of the ACK/NACK signals can be carried on the R-ACKCH on the Q-branch. FIG. 3 shows an example of such a channel structure 300 when more than two ACK/NACK signals are to be transmitted on the reverse link. As shown in FIG. 3, inputs 301 to on the I-branch include an Auxiliary Pilot relative gain, a PRI relative gain, an ACK relative gain, a DSC relative gain, and a data relative gain. The ACK relative gain and the DSC relative gain are time multiplexed via a multiplexer 303. The inputs 301 are summed at summer 305 and provided to a quadrature spreading logic 307. The I-branch also includes a baseband filter 309, which outputs to a mixer 311 that mixes the filtered signal with an orthogonal signal.

With respect to the Q-branch, the inputs 313 include a DRC relative gain, a data relative gain, and an ACK relative gain. In this example, the ACK relative gain (associated with channel Q) supports ACK/NACK signaling on the Q-branch. The inputs 313 are feed to a summer 315, in which the resultant signal is provided to the quadrature spreading logic 307. As with the I-branch, the Q-branch includes a baseband filter 317. The filter 317 outputs to a mixer 311 that mixes the filtered signal with an orthogonal signal (i.e., orthogonal to that of the I-branch mixer 311). The output signal is formed by the summer 321.

According to one embodiment of the invention, assuming the transmission duration of the ACK/NACK signal for each carrier is ¼ slot, a total of up to 6 ACK/NACK signals (e.g., for a total of 6 carriers on the forward link) can be sent on a single reverse carrier. This capability can accommodate most of the multi-carrier usage scenario in practical systems. In an exemplary embodiment, the R-ACKCH on the Q-branch can use the same Walsh code on the I-branch, e.g., W₁₂³², for spreading.

Walsh code is one of the orthogonal codes that are popularly used in CDMA systems. A set of orthogonal codes are the codes that have following characteristic:

$${\sum }_{k = 0}^{M - 1} {ϕ}_{i} ( kT ) {ϕ}_{j} ( kT ) = 0$$

$$i \neq j$$

where φᵢ(kT) and φⱼ(kT) are the i th and j th orthogonal members of an orthogonal set, M is the size of the set, and T is the symbol duration. A set of orthogonal codes are the codes having 0 cross-correlation value when τ=0, between any two pair of codes in the set.

Each row of the matrix Hₙ forms a code of length n. As an example, the construction of a set of Walsh code of length 4 is shown below.

$${H}_{1} = [ 0 ]$$

$${H}_{2} = [ \begin{matrix}0 & 0 \\ 0 & 1\end{matrix} ]$$

$${H}_{4} = [ \begin{matrix}0 & 0 & 0 & 0 \\ 0 & 1 & 0 & 1 \\ 0 & 0 & 1 & 1 \\ 0 & 1 & 1 & 0\end{matrix} ]$$

Therefore, the four Walsh codes length 4 are {0, 0, 0, 0}, {0, 1, 0, 1}, {0, 0, 1, 1} and {0, 1, 1, 0}.

The circuitry for providing the Walsh covers and PN sequences to the quadrature spreading logic 307 includes a mixer (or multiplier) 323 that mixes an I-channel short PN sequence with an I-channel user long PN sequence. Also, the circuitry includes a mixer 325 for the Q-channel, whereby the Q-channel short PN sequence is mixed with a Q-channel user long PN sequence; the resultant signal is fed to a decimator logic 327, whose output is mixed, using mixer 329, with Walsh covers. The Walsh covers and PN sequences are represented with ±1 values with mapping +1 for binary “0” and −1 for binary “1.”

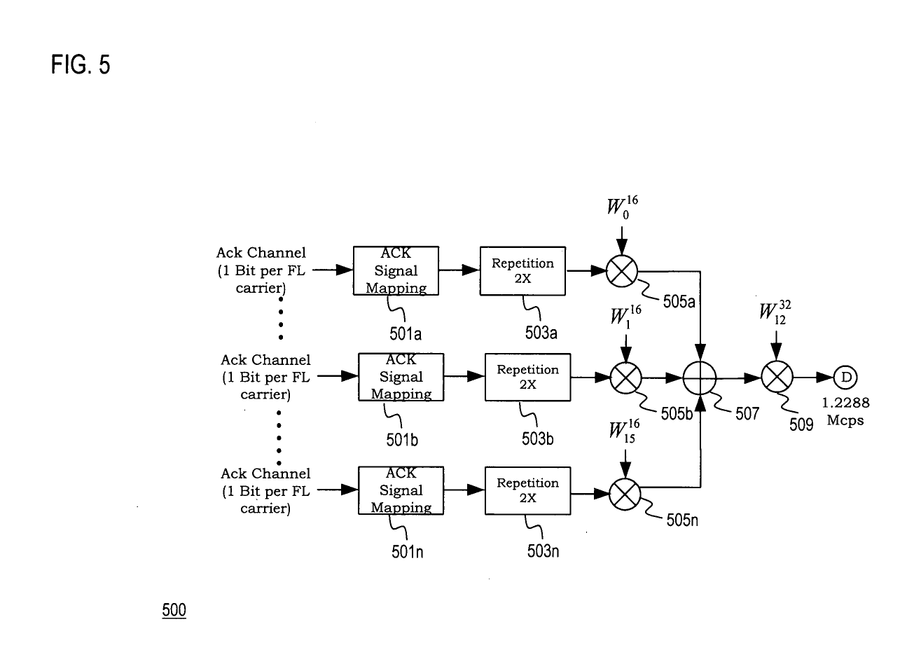

As in the channel structure 400 of FIG. 4, for the case where CDM (Code Division Multiplexing) of multiple ACK/NACK signals are used (i.e., “CDMed”), the ACK/NACK signals are allocated to both I and Q branches of the transmitter. The inputs and components 401-429 follow those (e.g., 301-329) of the channel structure of FIG. 3. On each branch, if there are more than two ACK/NACK signals, they are carried in a CDM fashion as described below with respect to FIG. 5. Unlike the structure of FIG. 3, in an exemplary embodiment, because CDM is utilized, the transmission duration of the ACK/NACK for each carrier remains the same as in 1×EV-DO, i.e., ½ slot. In the Q branch, since there is no Data Source Control (DSC) channel time multiplexed with the R-ACKCH, after transmission of the first ½ slot, the rest of the ½ slot can be either DTXed (not transmitted) or used for transmission of ACK/NACK signals to support more carriers. Also, if N and M in FIG. 4 equal to 1, a special case arises where the two ACK/NACK signals are neither TDM nor CDM, but rather separated and carried on different I and Q branches.

FIG. 5 is a diagram of channel structure of CDM (Code Division Multiplexing)-ACKs utilizing only the I branch. The channel structure of FIG. 5 involves Code Division Multiplexing (CDM) of ACK/NACK generated from multiple carriers by assigning one Walsh code to each ACK/NACK signals while maintaining the original ACK/NACK transmission duration (e.g., ½ slot). As shown, ACK signal mapping logic, 501a, 501b, 501n, output to respective repetition logic 503a, 503b, 503n, which repeat (e.g., 2×) the symbols and them to mixers 505a, 505b and 505n. The mixed signals (being mixed with the corresponding Walsh covers) are summed by adder 507, and the resultant signal is mixed with another cover—e.g., W₁₂³².

This approach provides the R-ACKCH being carried in only the I-branch. When the number of forward link carriers increase, the total transmission power of multiple ACK/NACK over the I-Branch may cause I-Q branch power imbalance; the channel structures of FIGS. 3 and 4 do not exhibit this imbalance.

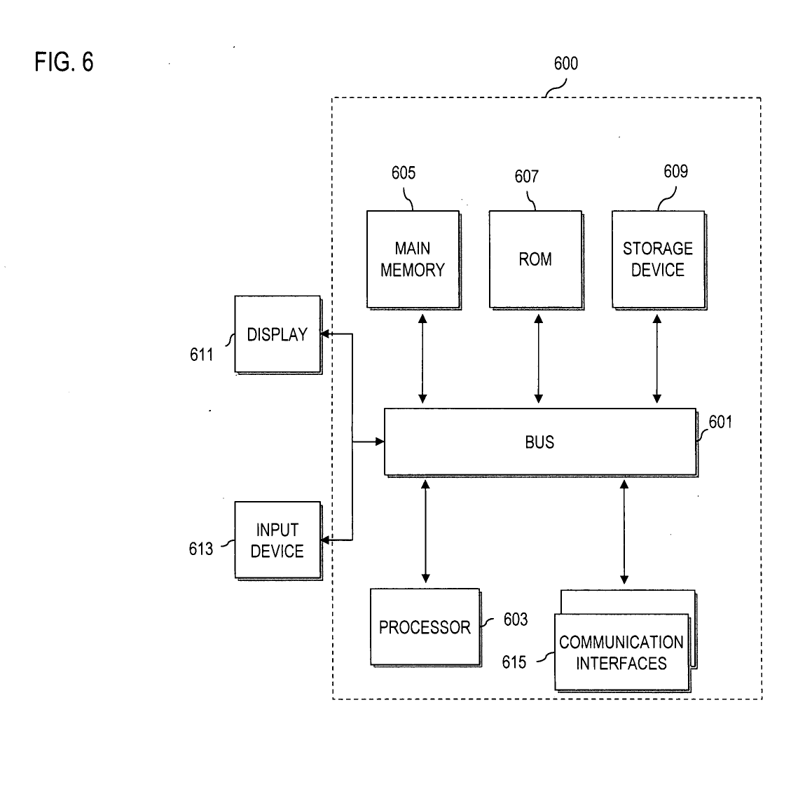

One of ordinary skill in the art would recognize that the processes for providing acknowledgement signaling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

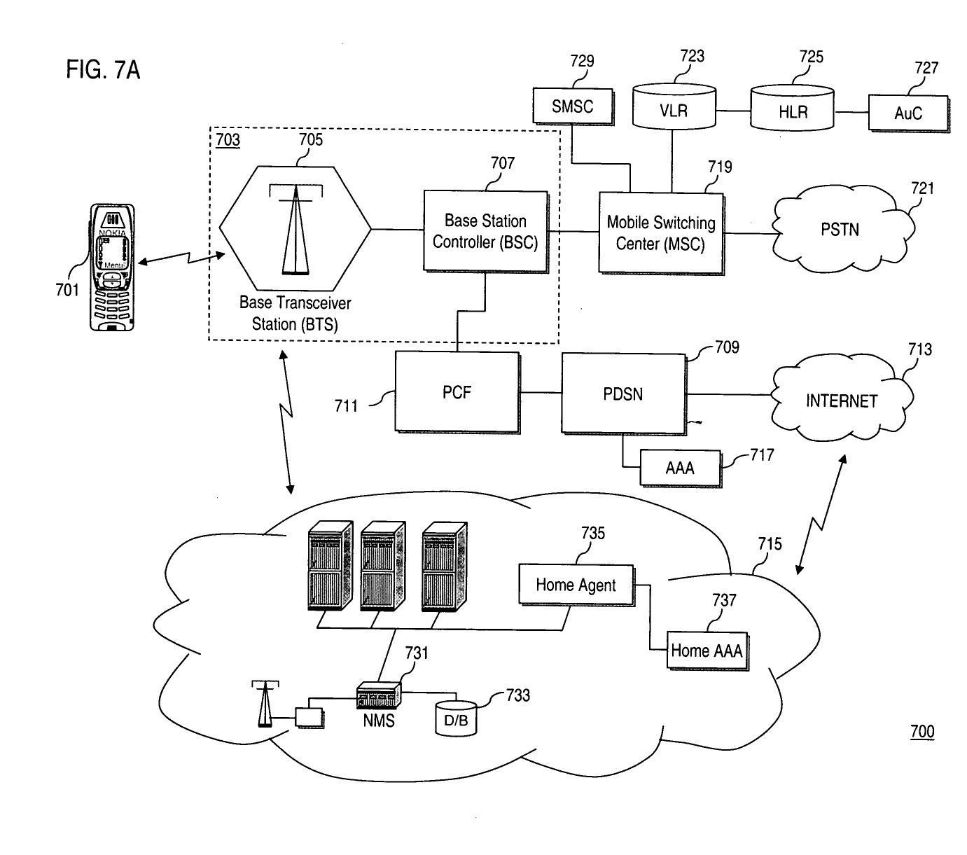

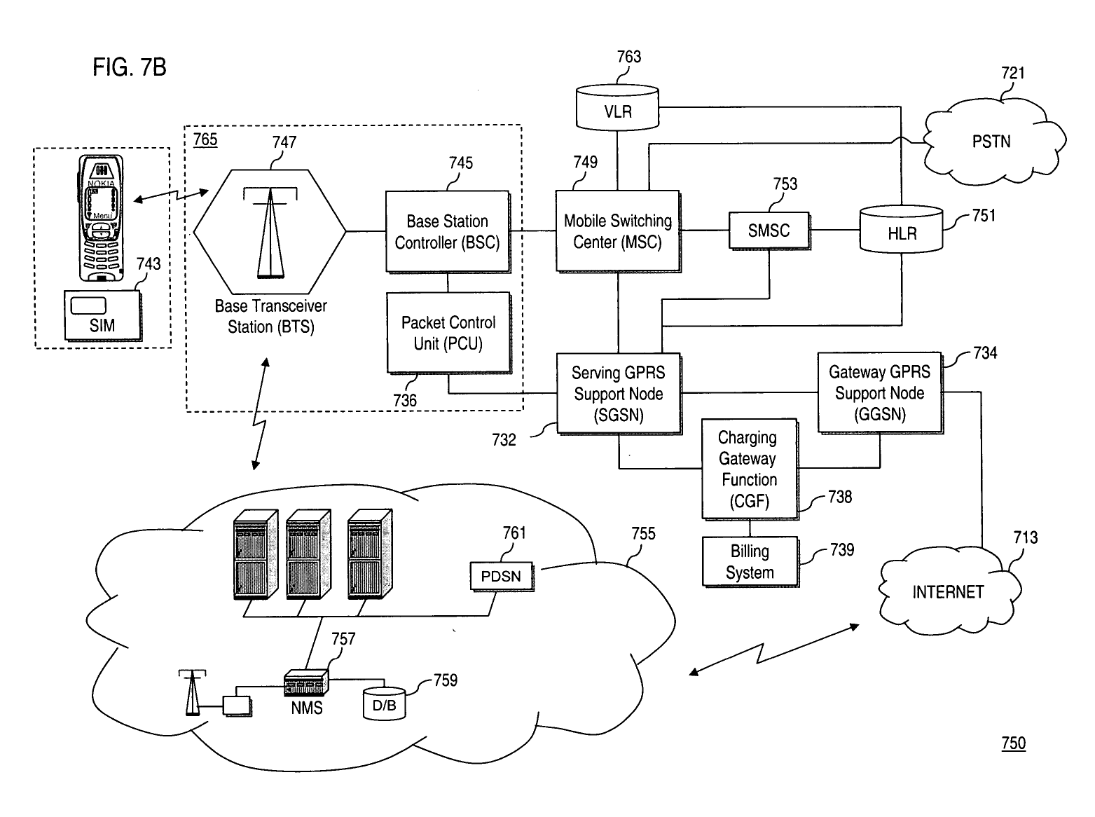

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit PCU (1336) and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 731 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/HLR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging functionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (IP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 733 to allow user data to be tunneled between the two entities as well as to and from the network 750. When external data networks initialize sessions over the GPRS network 750, the GGSN 734 queries the HLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

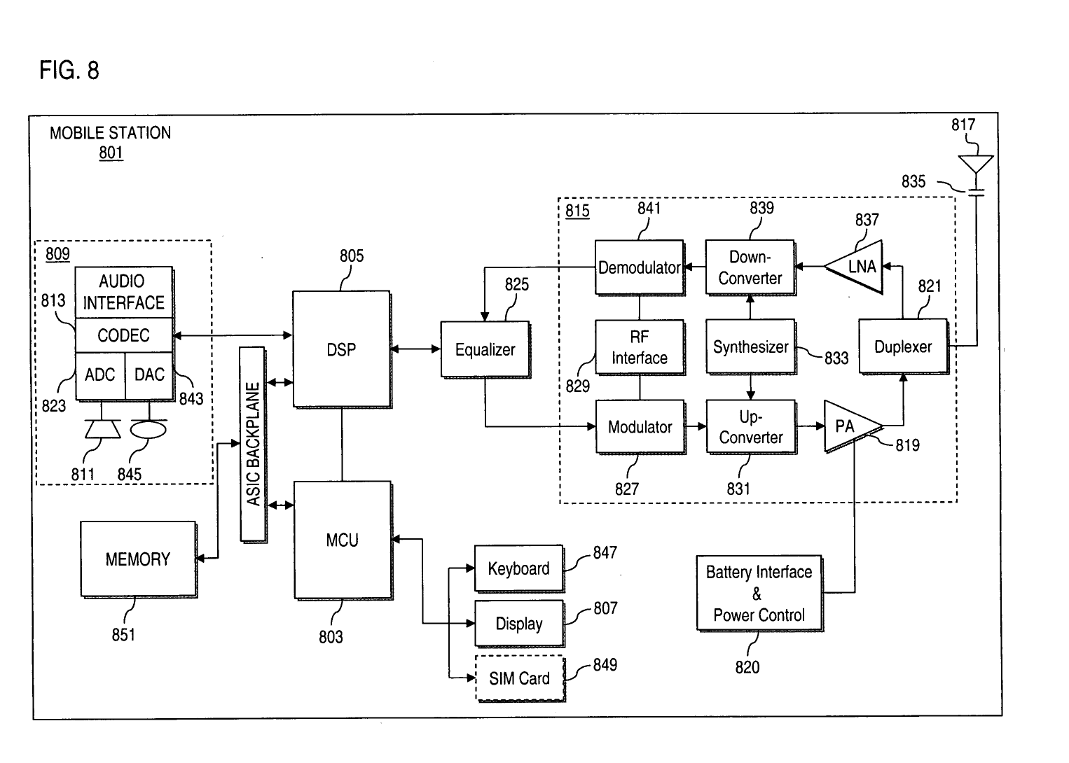

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 1005. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

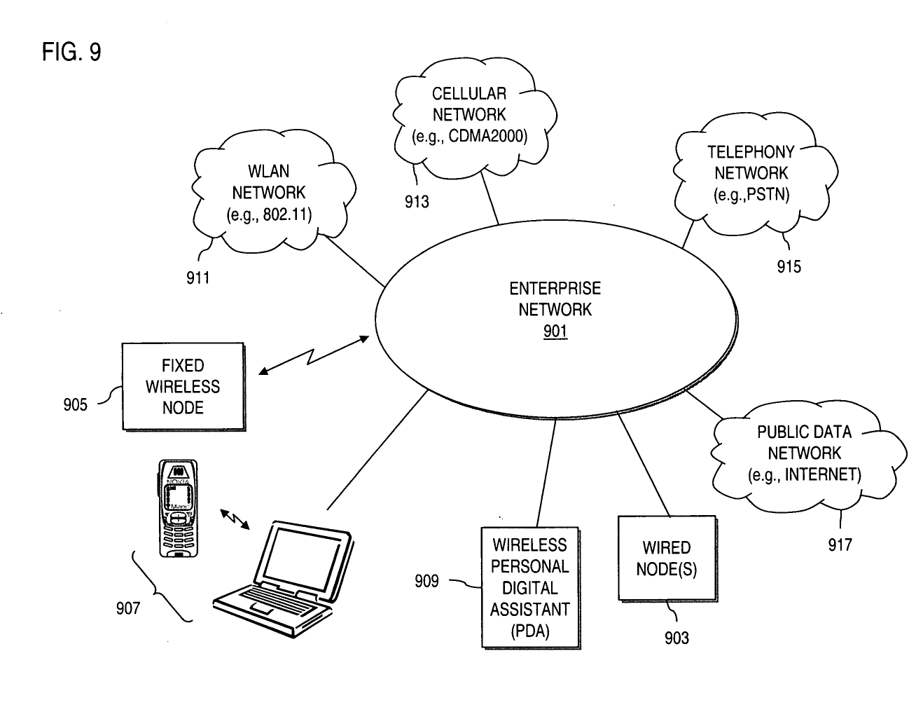

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905-909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 916 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a plurality of acknowledgement signals corresponding to a plurality of transmission carriers, the transmission carriers being associated with a first direction of transmission;
allocating some of the acknowledgement signals to a first transmitter branch;
allocating remaining ones of the acknowledgement signals to a second transmitter branch; and
transmitting the plurality of acknowledgement signals over a single transmission carrier associated with a second direction of transmission.

2. A method according to claim 1, wherein the first transmitter branch is an I-branch, and the second transmitter branch is a Q-branch.

3. A method according to claim 1, wherein the acknowledgement signals are Time Division Multiplexing (TDM) signals.

4. A method according to claim 3, further comprising:
applying a common Walsh code for the Q-branch and the I-branch for spreading the acknowledgement signals.

5. A method according to claim 1, wherein the acknowledgement signals are Code Division Multiplexing (CDM) signals.

6. A method according to claim 1, wherein the transmission carriers support a data service in a cellular network, the first direction being in a forward direction and the second direction being in a reverse direction.

7. An apparatus comprising:
circuitry configured to receive a plurality of acknowledgement signals corresponding to a plurality of transmission carriers, the transmission carriers being associated with a first direction of transmission,
wherein the circuitry is further configured to allocate some of the acknowledgement signals to a first transmitter branch and remaining ones of the acknowledgement signals to a second transmitter branch, the plurality of acknowledgement signals being transmitted over a single transmission carrier associated with a second direction of transmission.

8. An apparatus according to claim 7, wherein the first transmitter branch is an I-branch, and the second transmitter branch is a Q-branch.

9. An apparatus according to claim 7, wherein the acknowledgement signals are Time Division Multiplexing (TDM) signals.

10. An apparatus according to claim 9, wherein the circuitry is further configured to apply a common Walsh code for the Q-branch and the I-branch for spreading the acknowledgement signals.

11. An apparatus according to claim 7, wherein the acknowledgement signals are Code Division Multiplexing (CDM) signals.

12. An apparatus according to claim 7, wherein the transmission carriers support a data service in a cellular network, the first direction being in a forward direction and the second direction being in a reverse direction.

13. A system comprising the apparatus of claim 9.

14. A system according to claim 7, further comprising:
means for receiving user input; and
a display configured to display the user input.

15. A system according to claim 7, further comprising:
means for transmitting the acknowledgement signals using spread spectrum.

16. A method comprising:
transmitting a plurality of acknowledgement signals corresponding to a plurality of transmission carriers to a terminal, the transmission carriers being associated with a first direction of transmission, wherein some of the acknowledgement signals are allocated to a first transmitter branch of the terminal and remaining ones of the acknowledgement signals are allocated to a second transmitter branch of the terminal; and
receiving the plurality of acknowledgement signals over a single transmission carrier associated with a second direction of transmission.

17. A method according to claim 16, wherein the first transmitter branch is an I-branch, and the second transmitter branch is a Q-branch.

18. A method according to claim 16, wherein the acknowledgement signals are Time Division Multiplexing (TDM) signals.

19. A method according to claim 18, wherein the terminal is configured to apply a common Walsh code for the Q-branch and the I-branch for spreading the acknowledgement signals.

20. A method according to claim 16, wherein the acknowledgement signals are Code Division Multiplexing (CDM) signals.

21. A method according to claim 16, wherein the transmission carriers support a data service in a cellular network, the first direction being in a forward direction and the second direction being in a reverse direction.

22. An apparatus comprising:
a first communication interface configured to transmit a plurality of acknowledgement signals corresponding to a plurality of transmission carriers to a terminal, the transmission carriers being associated with a first direction of transmission, wherein some of the acknowledgement signals are allocated to a first transmitter branch of the terminal and remaining ones of the acknowledgement signals are allocated to a second transmitter branch of the terminal; and
receiving the plurality of acknowledgement signals over a single transmission carrier associated with a second direction of transmission.

23. An apparatus according to claim 22, wherein the first transmitter branch is an I-branch, and the second transmitter branch is a Q-branch.

24. An apparatus according to claim 22, wherein the acknowledgement signals are Time Division Multiplexing (TDM) signals.

25. An apparatus according to claim 24, wherein the terminal is configured to apply a common Walsh code for the Q-branch and the I-branch for spreading the acknowledgement signals.

26. An apparatus according to claim 22, wherein the acknowledgement signals are Code Division Multiplexing (CDM) signals.

27. An apparatus according to claim 22, wherein the transmission carriers support a data service in a cellular network.

28. A system comprising the apparatus of claim 22.
